(19) United States
(12) Patent Application Publication
(10) Pub. No.: US 2007/0045883 A1
(43) Pub. Date: Mar. 1, 2007

(54) Spin replicated flexible and concentrically registered stamper and stamped optical disk

(75) Inventor: Barry E. Brovold, St. Paul, MN (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 11/215,921

(22) Filed: Aug. 30, 2005

(51) Int. Cl. B29D 17/00; B29D 11/00; G03C 5/00; G02B 1/12

(52) U.S. Cl. 264/1.33; 264/1.36; 430/321

(57) ABSTRACT

The disclosure is directed to techniques to transfer data information to optical disks. A stamper is formed by registering a disk-shaped stamper substrate to a master through a common centering pin. A resin ring is added to the inner edge of the master to be sandwiched between the disk-shaped stamper substrate and the master. Spinning the assembly at high speeds forces the resin to form a uniform layer between each disk, thus forming an inverse surface pattern on the disk-shaped stamper substrate. Once ultraviolet light passes through the transparent disk-shaped stamper substrate to cure the resin, the stamper can be removed from the master and used to form readable, or correct, surface patterns in data layers for optical disks. Concentrically registered stampers may be used to create optical disks with two or more layers without the need to optically register the center of the data layer after formation.

### TECHNICAL FIELD

The invention relates to data storage media and, more particularly, optical data storage media.

### BACKGROUND

Optical data storage disks have gained widespread acceptance for the storage, distribution and retrieval of large volumes of information. Optical data storage disks include, for example, audio CD (compact disc), CD-R (CD-recordable), CD-RW (CD-rewritable) CD-ROM (CD-read only memory), DVD (digital versatile disk or digital video disk), DVD-RAM (DVD-random access memory), and various other types of writable or rewriteable media, such as magneto-optical (MO) disks, phase change optical disks, and others. Some newer formats for optical data storage disks are progressing toward smaller disk sizes and increased data storage density. For example, some new media formats boast improved track pitches, increased storage through multiple data layers and increased storage density using blue-wavelength lasers for data readout and/or data recording.

Optical data storage disks are typically produced by first making a data storage disk master that has a surface pattern that represents encoded data on the master surface. The surface pattern, for instance, may be a collection of grooves or other features that define master pits and master lands, e.g., typically arranged in either a spiral or concentric manner. The master is typically not suitable as a mass replication surface, as the master features are typically defined within an etched photoresist layer formed over a master substrate.

After creating a suitable master, that master can be used to make a stamper, which is less fragile than the master. The stamper is typically formed of electroplated metal or a hard plastic material, and has a surface pattern that is the inverse of the surface pattern encoded on the master. An injection mold can use the stamper to fabricate large quantities of replica disks. Also, photopolymer replication processes, such as rolling bead processes, have been used to fabricate replica disks using stampers. In any case, each replica disk may contain the data and tracking information that was originally encoded on the master surface and preserved in the stamper. The replica disks can be coated with a reflective layer and/or a phase change layer, and are often sealed with an additional protective layer. Additional stampers (later generation stampers) can also be made from the first generation stamper, to improve productivity with respect to one original master, or to allow for master features to be formed as the inverse of the desired replica disk features.

Blue disk media formats, such as Blu-Ray and HD-DVD, may also use similar mastering-stamping techniques. The blue disk media formats may be compatible with a blue-laser drive head that operates at a wavelength of approximately 405 nm. As used herein, the term blue disk media (or blue disks) refers to optical disk media having a data storage capacity of greater than 15 gigabytes (GB) per data storage layer of the disk. The blue disk media formats include optically transmissive cover layers bonded over the optical disk with different thicknesses specified by the different blue disk media formats.

### SUMMARY

In general, the invention is directed to techniques to transfer data information to create optical disks. A stamper is formed by registering a disk-shaped stamper substrate to a master through a common centering pin. A resin ring is added to the inner edge of the master to be sandwiched between the disk-shaped stamper substrate and the master. By spinning the assembly at high speeds, the resin can be forced to form a uniform layer between each disk, thus forming an inverse surface pattern on the disk-shaped stamper substrate. Ultraviolet (UV) light is then passed through the transparent disk-shaped stamper substrate to cure the resin. Once the resin is cured, the stamper can be removed from the master and used to form readable, or correct, data layers for optical disks.

Concentrically registered stampers may be used to create optical disks with two or more layers without the need to optically register the center of the data layer after formation. Each layer is produced by spinning out a resin between the last surface of the optical disk and the stamper. Once cured by UV light, the stamper may be removed from the cured resin to allow thin films to cover the readable surface pattern, which then completes the data layer. Once the desired number of layers are produced, a cover layer may be bonded to the last readable surface pattern to protect the data layers of the optical disk.

In one embodiment, the invention provides a method comprising centering a master on a centering pin, the master including mastered surface features, applying a first curable material to the master near the centering pin, and placing a disk-shaped stamper substrate on the centering pin to contact the first curable material, wherein the centering pin registers the disk-shaped stamper substrate to the master. The method further comprises coating the disk-shaped stamper substrate with the first curable material by spinning the master and the disk-shaped stamper substrate, wherein the first curable material coated on the disk-shaped stamper substrate forms an inverse of the mastered surface features on the master, and curing the first curable material to the disk-shaped stamper substrate by directing light through the disk-shaped stamper substrate to form a stamper, wherein the stamper comprises the first curable material cured to the disk-shaped stamper substrate.

In another embodiment, the invention provides a method comprising centering a disk-shaped replica substrate on a first spindle, wherein the first spindle has a diameter less than a second spindle, applying a curable material to the disk-shaped replica substrate near the second spindle, and centering a center-registered stamper on the second spindle to contact the curable material, wherein the second spindle registers the center-registered stamper to the disk-shaped replica substrate. The method further comprises coating the disk-shaped replica substrate with the curable material by spinning the disk-shaped replica substrate, wherein the curable material coated on the disk-shaped replica substrate creates a readable surface pattern opposite an inverse surface pattern on the center-registered stamper, curing the curable material, and applying one or more films to the readable surface pattern to create the featured layer.

In another embodiment, the invention provides a method comprising centering a first stamper on a centering pin, wherein the first stamper includes a surface pattern, applying a first curable material to the first stamper near the centering pin, and placing a disk-shaped stamper substrate on the centering pin to contact the first curable material, wherein the centering pin registers the disk-shaped stamper substrate to the first stamper. The method further comprises coating the disk-shaped stamper substrate with the first curable material by spinning the first stamper and the disk-shaped stamper substrate, wherein the first curable material coating the disk-shaped stamper substrate creates a surface pattern opposite the first stamper, and curing the first curable material by directing light through the disk-shaped stamper substrate to create a next-generation stamper, wherein the next-generation stamper comprises the first curable material cured to the disk-shaped stamper substrate.

The invention may provide one or more advantages. For example, center-registering the stamper to each previous data layer ensures accurate alignment of each data layer without the need to optically detect the surface pattern of each layer prior to adding the next layer. In addition, the stamper may be flexible which allows the stamper to bend and facilitate the separation of the stamper from the master. This bending may enable the stamper to be “peeled” off the inflexible master. Moreover, spin coating to create the stamper and each data layer enables a much greater uniformity in layer thickness when compared to the rolling bead method. Curing the spun coating through the stamper with UV light also provides stability to the surface pattern before being disturbed when removing the stamper. Further, creating a stamper to produce data layers of optical disks may be less expensive than creating many nickel masters.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a side view of an exemplary master and associated materials to create a stamper.

FIG. 2 is a flow diagram illustrating an exemplary method to create a stamper from a master.

FIG. 3 is a side view of an exemplary disk-shaped replica substrate and stamper to create a featured layer on the disk-shaped replica substrate.

FIG. 4 is a flow diagram illustrating an exemplary method to form a featured layer on a disk-shaped replica substrate with a stamper.

FIG. 5 is a side view of an exemplary disk-shaped replica substrate and cover layer to protect the featured layers of the moldable disk.

FIG. 6 is a flow diagram illustrating an exemplary method to apply a protective cover layer to a featured layer on a disk-shaped replica substrate.

FIG. 7 is a side view of an exemplary completed dual-layer optical disk on an assembly.

### DETAILED DESCRIPTION

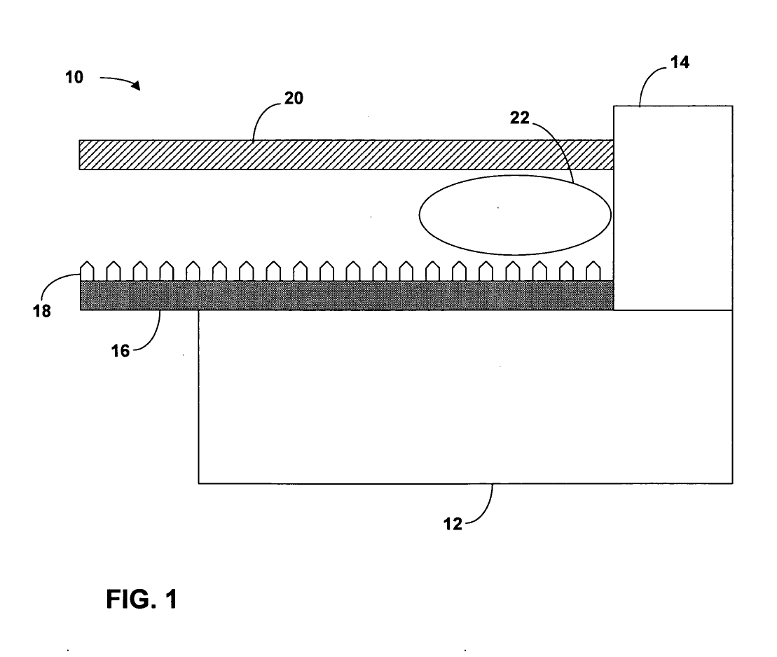

FIG. 1 is a side view of an exemplary master and associated materials to create a stamper. The illustration shows half of the total side view. Stamper assembly 10 includes the materials for creating a stamper with an inverse surface pattern with respect to master 16. Master 16 is placed over centering pin 14 through the middle of the master and set upon vacuum chuck 12. Master 16 includes readable surface pattern 18. First curable material 22 is applied to the inner edge of master 16, near centering pin 14. Disk-shaped stamper substrate 20 is placed to first curable material 22 over centering pin 14.

The stamper may be used to create a blue disk medium, i.e., an optical disk medium compatible with a blue-laser drive head or other laser drive heads. The blue-laser drive head may operate at a wavelength of approximately 405 nm. As used herein, the term blue disk media (or blue disks) refers to optical disk media having a data storage capacity of greater than 15 gigabyte (GB) per data storage layer of the disk. Examples of blue disk media include Blu-Ray and HD-DVD. However, it is understood that this disclosure may be directed to any optical disks containing one or more data layers.

Master 16 is created with a surface pattern identical to the surface pattern in a blue disk read by a laser drive head. Master 16 may be constructed of a metal alloy, polymer, or any other material that can be etched to form a surface pattern. Master 16 is not directly used to create surface patterns in a blue disk. Instead, stampers, such as a stamper, are created from master 16 to recreate the surface pattern of master 16 in a blue disk. In this exemplary embodiment, master 16 is coated with nickel at a thickness of 300 μm and has an outside diameter of 120 mm. Master 16 also includes an inner center hole with a diameter of 22 mm to allow the master to fit onto the 22 mm diameter centering pin 14. Other embodiments of master 16 may include a stamper of different dimensions or a different coating metal.

Master surface pattern 18 is contained in the nickel coating of master 16, and is substantially identical to the surface pattern to be transferred to an associated blue disk. Master surface pattern 18 is oriented up or away from vacuum chuck 12, to transfer an inverse surface pattern to disk-shaped stamper substrate 20. Vacuum chuck 12 secures master 16 to the chuck by applying negative pressure to the stamper.

Disk-shaped stamper substrate 20 is also placed over centering pin 14. Disk-shaped stamper substrate 20 is the main structure of the stamper. Disk-shaped stamper substrate 20 may be constructed of polyester or any other polymer. In this embodiment, disk-shaped stamper substrate has an outer diameter of 120 mm and an inner diameter of 22 mm. The polyester, or other material of disk 20, is also at least semi-transparent. Ultraviolet (UV) light may be able to pass through disk-shaped stamper substrate 20 in order to cure first curable material 22. Other types of radiation or wavelengths, however, could alternatively be used depending on material 22. In any case, by using centering pin 14 to hold master 16 and disk-shaped stamper substrate 20 in the right location ensures that the resulting stamper will be center-registered to the master. Center-registration of the stamper may reduce the need to optically locate the surface pattern, as is necessary with techniques like rolling bead processes. The stamper may also be center-registered with any moldable disk to create aligned surfaces of a blue disk.

First curable material 22 is used to transfer the inverse surface pattern to disk-shaped stamper substrate 20. First curable material 22 may comprise any material, such as a resin, that can be moldable in one stage to form to master 16 surface and can be cured afterwards to hold the inverse surface pattern received from master 16. First curable material 22 has a viscosity that allows the first curable material to flow over the surface of master surface pattern 18 when forced towards the outer edge of master 16. Generally, first curable material 22 comprises acrylate monomers, acrylate oligamers and photoinitiators. For example, first curable material 22 may comprise approximately 60-70% acrylate monomers, 15-40% acrylate oligamers, 3-10% photoinitiators, and possibly 0-5% of other additives.

Vacuum chuck 12 spins at a high angular speed to force first curable material 22 away from centering pin 14. Angular speeds may be between 4000 and 8000 revolutions per minute (rpm), and more ideally at approximately 6000 rpm. As first curable material 22 flows outward, disk-shaped stamper substrate 20 continues to adhere to the outwardly flowing first curable material. Spinning may be performed until first curable material 22 is of desired thickness. In this embodiment, first curable material 22 is spun until it is approximately 10 μm thick. In other embodiments, the thickness of first curable material 22 may be more or less than this thickness. While first curable material 22 thickness may vary radially with respect to disk-shaped stamper substrate 20, thickness may be consistent in the circumferential direction. For example, the circumferential thickness variation in one rotation may be less than 2 μm. Circumferential uniformity may allow the laser drive head to accurately follow the surface pattern. This process creates an inverse surface pattern of master surface pattern 18 that is adhered to disk-shaped stamper substrate 20.

First curable material 22 is also curable to hold the shape of master surface pattern 18 after spinning has been finished. Curing may be done by numerous methods, but this embodiment describes the use of UV light to cure first curable material 22 into a hard material. A UV light source directs UV light through disk-shaped stamper substrate 20 to harden and cure first curable material 22. Once first curable material 22 has cured, disk-shaped stamper substrate 20 can be removed from centering pin 14 with the cured first curable material still attached to the disk.

Disk-shaped stamper substrate 20 with cured first curable material 22 contains the inverse surface pattern from master 16. First curable material 22 is finally coated with a thin, 10 nm, nickel plating to harden the cured first curable material. A release agent may also be used to help the nickel surface release from other materials when transferring the surface pattern of the newly-created stamper. In some embodiments, nickel plating or adding release agents to the stamper may not be necessary to successfully transfer the inverse surface pattern of the stamper to another medium.

Master 16 is not used to repeatedly form surface patterns in other media such as blue disks due to numerous problems. For example, master 16 is fragile and using it to create many replications could damage master surface pattern 18. Further, master 16 is not flexible to facilitate removal from a new surface or transparent to allow UV curing.

However, the stamper may have a longer usable life than master 16 or other inflexible stampers. In addition, the stamper may be able to make many reproductions of its surface pattern. In this exemplary embodiment, the stamper is the first-generation stamper because it was produced from master 16. The stamper may be able to produce other stampers as well, each next-generation having an inverse surface pattern to the previous generation. For example, a stamper created from the first generation stamper would be a second generation stamper. The second generation stamper would create a third generation stamper. In this case, the first generation and third generation stampers would have identical surface patterns.

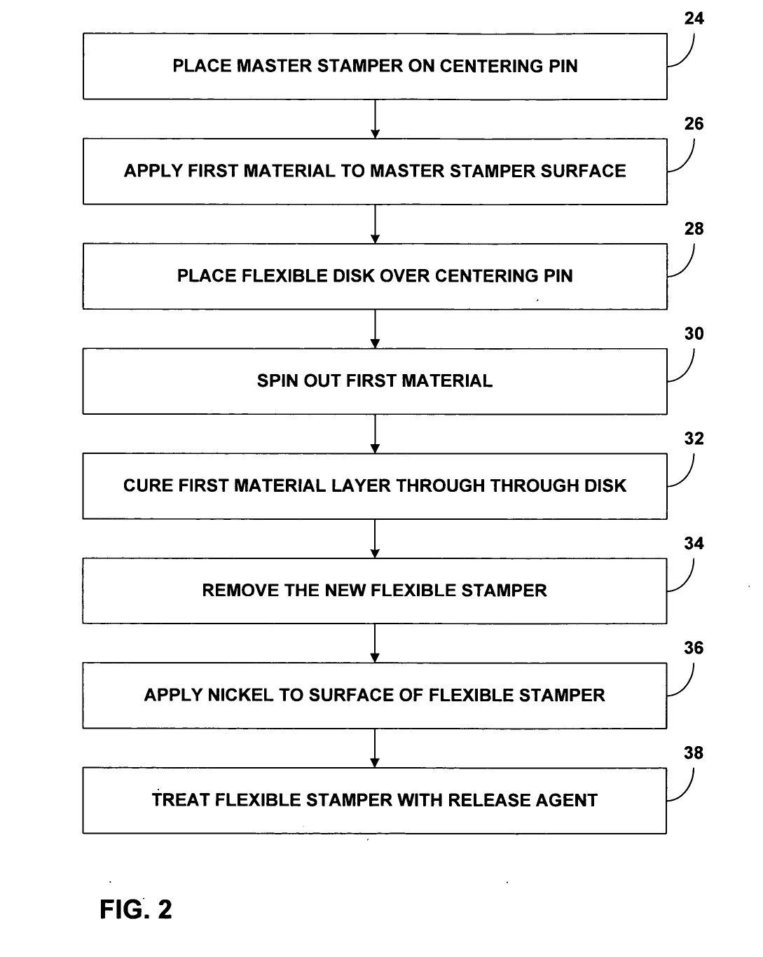

FIG. 2 is a flow diagram illustrating an exemplary method to create a stamper from a master. Master 16 is placed on centering pin 14 and slid down until it contacts vacuum chuck 12 (24). Centering pin 14 is located at the center of master 16 and master surface pattern 18 is oriented opposite vacuum chuck 12.

First curable material 22 is applied to master 16 in a ring near centering pin 14 (26). In some embodiments, multiple concentric rings or a covering layer of first curable material 22 may be applied to master 16. Disk-shaped stamper substrate 20 is carefully placed over centering pin 14 to contact first curable material 22 (28). In some embodiments, slightly bending disk-shaped stamper substrate 20 may help to contact first curable material 22 without trapping bubbles of air between disk-shaped stamper substrate 20 and first curable material 22. At this point, disk-shaped stamper substrate 20 may only be contacting first curable material 22 near centering pin 14. Next, vacuum chuck 12 spins at 6000 rpm to spread first curable material 22 radially outward to fill in the space between master surface pattern 18 and disk-shaped stamper substrate 20 (30). Once the first curable material is reduced to a thickness of approximately 10 μm, spinning stops. In other embodiments, the thickness of first curable material 22 may be greater or less than 10 μm.

First curable material 22 must be cured before it is removed from master 16. A UV lamp directs UV light through disk-shaped stamper substrate 20 to cure first curable material 22 (32). In other embodiments, a different type of electromagnetic energy may be used to cure first curable material 22. For example, heat may be used instead of a UV lamp. Once first curable material 22 has cured, the new stamper, e.g., disk-shaped stamper substrate 20 and cured first curable material 22 with an inverse surface pattern of master 16, may be carefully flexed and removed from master 16 (34). The new stamper may be flexible for removing it from master 16 or other surfaces after curing is completed. For example, the bending modulus of the stamper may generally be between 1350 and 2480 MPa.

In some embodiments, the stamper may be ready to be used in creating blue disks after it is removed from master 16. However, the exemplary embodiment of FIG. 2 includes more steps before the stamper is ready to be used. First, a nickel layer of approximately 10 nm is added to the cured first curable material 22 to make the stamper more robust (36). The nickel layer is then treated with a release agent to facilitate the removal of the stamper from any subsequent layer productions (38).

At this point, the stamper may be used to create other stampers or readable surface patterns for blue disks. The stamper may create a readable surface pattern, or an inverse of the inverse surface pattern of the stamper which is the same as master surface pattern 18, on another blue disk. Similar to the creation of the stamper in FIG. 2, the stamper may be center-registered to another surface and material may be spun at high speeds to produce the new surface pattern.

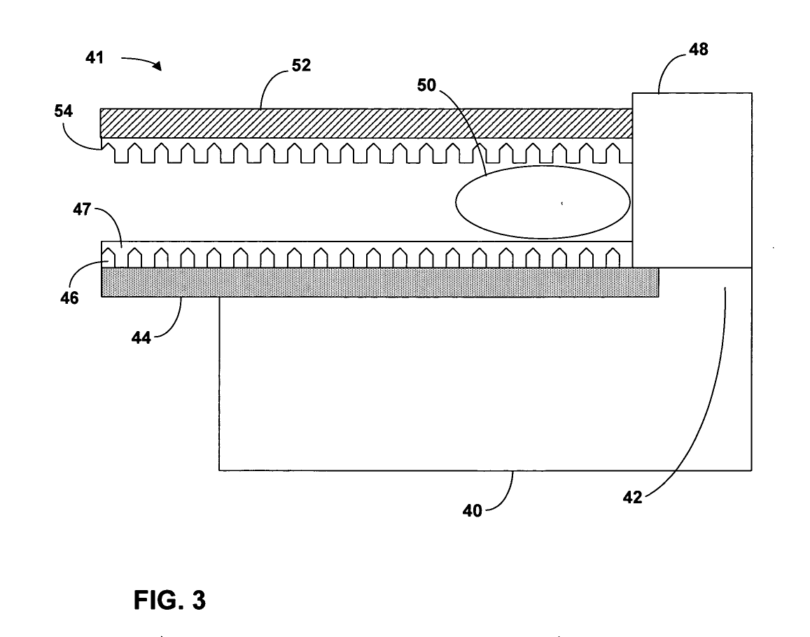

FIG. 3 is a side view of an exemplary disk-shaped replica substrate and stamper to create a featured layer on the disk-shaped replica substrate. Disk assembly 41 includes disk vacuum chuck 40 attached to first spindle 42. Disk-shaped replica substrate 44 rests on disk vacuum chuck 40 registered to first spindle 42. Disk-shaped replica substrate 44 already includes readable surface pattern 46 and thin films 47. Readable surface pattern 46 and thin films 47 create the first data layer of disk-shaped replica substrate 44. Second spindle 48 is lowered onto first spindle 42 to seal disk-shaped replica substrate 44 to disk vacuum chuck 40. Second curable material 50 is applied to the first data layer near second spindle 48, which stamper 52 with inverse surface pattern 54 is placed on top of. In this embodiment, first spindle 42 has a diameter that is less than the diameter of second spindle 48. In this case, first spindle 42 may be the narrow spindle and second spindle 48 may be the wide spindle. The wider second spindle 48 may fit around the narrower first spindle 42.

Disk-shaped replica substrate 44 is the support structure of the resulting blue disk created by stamper 52. Disk-shaped replica substrate 44 may comprise a robust polymer, such as polyethylene or polyurethane, and has an outer diameter of approximately 120 mm. Disk-shaped replica substrate 44 also includes the first data layer consisting of readable surface pattern 46 and thin films 47. Thin films 47 are added to readable surface pattern 46 to refract light at a different angle than readable surface pattern 46, which is optically transmissive. Thin films 47 also act to fill in the gaps in readable surface pattern 46 to create a smooth surface for adding another readable surface pattern or finishing the blue disk with a cover layer. While disk-shaped replica substrate 44 already includes a first data layer, stamper 52 may be used to create the first data layer of another disk-shaped replica substrate. In this embodiment, stamper 52 is used to add a second readable surface pattern on disk-shaped replica substrate 44. In other embodiments, stamper 52 could be used to add the third, fourth, or Nth readable surface pattern, where N is any integer.

Disk-shaped replica substrate 44 is center-registered to first spindle 42. First spindle 42 has a diameter of 17 mm, which is smaller than centering pin 14 at 22 mm. Second spindle 48 is 22 mm in diameter and is set down over first spindle 42. Second spindle 48 acts as a seal between disk-shaped replica substrate 44 and disk vacuum chuck 40 and the center-registration point for stamper 52. While the diameters of first spindle 42 and second spindle 48 do not have to be 17 mm and 22 mm, respectively, second spindle 48 should be the same diameter as centering pin 14. In some embodiments, centering pin 14, first spindle 42 and second spindle 48 have all the same diameters.

Second curable material 50 is used to transfer the readable surface pattern, or inverse of inverse surface pattern 54, of stamper 52 to moldable disk 44. Second curable material 50 may comprise any material, such as a resin, that can be moldable in one stage to form to a readable surface pattern from inverse surface pattern 56 and can be cured afterwards to hold the readable surface pattern to moldable disk 44. Second curable material 50 has a viscosity that allows the second curable material to flow over the surface of inverse surface pattern 54 when forced towards the outer edge of moldable disk 44. In this embodiment, second curable material 50 has a higher viscosity than first curable material 22 from FIG. 1. However, second curable material 50 may be substantially similar to first curable material 22 with the exceptions of modifications for viscosity as described and adhesion to each respective thin films or other interfaces.

Vacuum chuck 40 spins at a high angular speed to force second curable material 50 away from second spindle 48. Angular speeds may be between 4000 and 8000 revolutions per minute (rpm), and more ideally at approximately 6000 rpm. As second curable material 50 flows outward, thin films 47 of disk-shaped replica substrate 44 adhere to the outwardly flowing second curable material. Spinning may be performed until second curable material 50 is of desired thickness. In this embodiment, second curable material 50 is spun until it is approximately 25 μm thick. In other embodiments, the thickness of second curable material 50 may be more or less than this thickness. While second curable material 50 thickness may slightly vary radially with respect to disk-shaped replica substrate 44, thickness may be consistent in the circumferential direction. For example, the circumferential thickness variation in one rotation may be less than 2 μm. Circumferential uniformity may allow the laser drive head to accurately follow the surface pattern. This process creates a readable surface pattern from inverse surface pattern 54 that is adhered to thin films 47 of disk-shaped replica substrate 44.

Second curable material 50 is also curable to hold the shape of inverse surface pattern 54 after spinning has been finished. Curing may be done by numerous methods, but this embodiment describes the use of UV light to cure second curable material 50 into a hard material. A UV light source directs UV light through stamper 52 to harden and cure second curable material 50. Once second curable material 50 has cured, stamper 52 can be removed from second spindle 48 with the cured second curable material still attached to the first data layer of disk-shaped replica substrate 44.

At this point, disk-shaped replica substrate 44 includes a first data layer concentrically aligned to the recently cured readable surface pattern. In this embodiment, readable surface pattern 46 and the newly added readable surface pattern are substantially identical to each other. The new readable surface pattern is the inverse of inverse surface pattern 54 on stamper 52. Once the process is complete, disk-shaped replica substrate 44 includes two data layers. In some embodiments, more data layers may be added as required by user specifications. Upon adding multiple layers, it may be beneficial to use the same stamper 52 for the readable surface pattern in each layer. However, other embodiments may use a different stamper for each layer of the resulting blue disk.

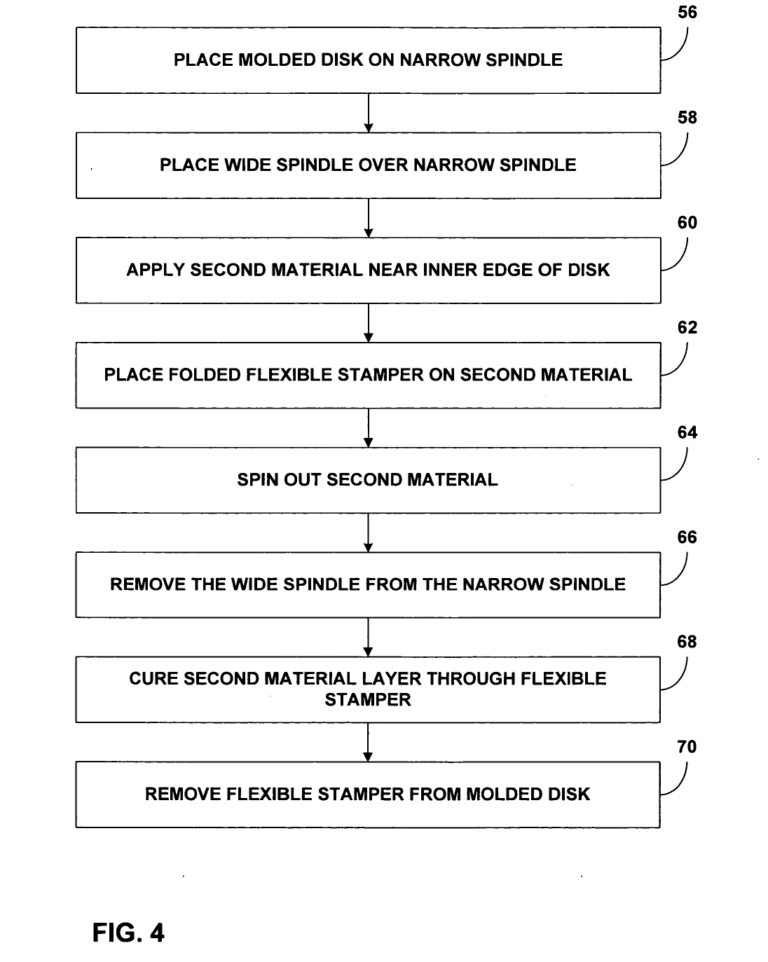

FIG. 4 is a flow diagram illustrating an exemplary method to form a featured layer on a disk-shaped replica substrate with a stamper. Disk-shaped replica substrate 44, with one data layer already formed, is placed on first spindle 42 and slid down until it contacts vacuum chuck 40 (56). First spindle 42 is located at the center of disk-shaped replica substrate 44 and readable surface pattern 46 is oriented opposite disk vacuum chuck 40. Next, second spindle 48 is placed over first spindle 42 (58). Second spindle 48 serves to seal disk-shaped replica substrate 44 from disk vacuum chuck 40.

Second curable material 22 is applied to thin films 47 of disk-shaped replica substrate 44 in a ring near second spindle 48 at the inner edge of disk-shaped replica substrate 44 (60). In some embodiments, multiple concentric rings or a covering layer of second curable material 50 may be applied to thin films 47. Stamper 52 is carefully placed over second spindle 48 to contact second curable material 50 (62). In some embodiments, slight bending of stamper 52 may be performed to help contact second curable material 50 without trapping bubbles of air between stamper 52 and second curable material 50. At this point, stamper 52 may only be contacting second curable material 50 near second spindle 48. Next, disk vacuum chuck 40 spins at 6000 rpm to spread second curable material 50 radially outward to fill in the space between thin films 47 and stamper 52 (64). Once second curable material 50 is reduced to a thickness of approximately 25 μm, spinning stops. In other embodiments, the thickness of second curable material 50 may greater or less than 25 μm.

Second spindle 48 is removed from disk assembly 41 after spinning stops (66). Second curable material 50 must be cured before stamper 52 may be removed from second curable material 50. A UV lamp directs UV light through stamper 52 to cure second curable material 50 (68). In other embodiments, a different type of electromagnetic energy may be used to cure second curable material 50. Also, heat may be used instead of a UV lamp. Once second curable material 50 has cured, stamper 52 may be carefully flexed and removed from the new readable surface pattern created by second curable material 50 on disk-shaped replica substrate 44 (70). The new readable surface pattern is center-registered and identical to readable surface pattern 46 in content and orientation.

In some embodiments, the disk-shaped replica substrate may contain two readable surface patterns to which a cover layer may be applied. In other embodiments, the process, may be repeated to create one or more readable surface patterns or data layers, on disk-shaped replica substrate 44. Stamper 52 may be used for this purpose or other stampers may be used instead. Alternatively, disk-shaped replica substrate 44 may contain surface patterns oriented in different directions. This approach would be dependent on the laser drive head used to read these surface patterns.

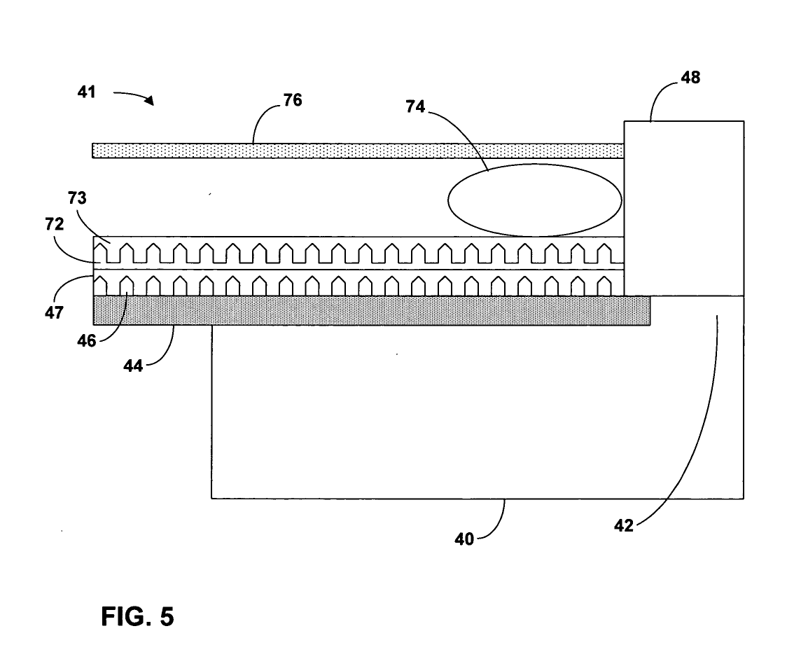

FIG. 5 is a side view of an exemplary disk-shaped replica substrate and cover layer to protect the featured layers of the moldable disk. In the example of FIG. 5, disk-shaped replica substrate 44 has two readable surface patterns 46 and 72 which create the two layers of the blue disk. Disk assembly 41 is used again and includes disk vacuum chuck 40 and first spindle 42. Second spindle 48 seals disk-shaped replica substrate 44 from disk vacuum chuck 40. Disk-shaped replica substrate 44 includes readable surface pattern 46, thin films 47, readable surface pattern 72 and thin film 73. Final curable material 74 is applied to disk-shaped replica substrate 44 below cover layer 76. Cover layer 76 protects the data layers of the blue disk from damage during use or transport of the blue disk.

Disk-shaped replica substrate 44 has two data layers coupled to it which include the first data layer of readable surface pattern 46 and thin films 47 and the second data layer of readable surface pattern 72 and thin films 73. Each readable surface pattern is identical to each other, and thin films 47 and 73 provide an optically different medium than the optically transmissive patterns. Thin films 47 and 73 may be similar or identical, but their refractive index allows a laser drive head to identify the pits and bumps of each readable surface pattern. Thin films 47 and 73 also act to fill in the gaps in readable surface patterns 46 and 72, respectively, to create a smooth surface for finishing the blue disk with cover layer 76. In some embodiments, disk-shaped replica substrate 44 may include three, four, or N readable surface patterns, where N is any integer.

Disk-shaped replica substrate 44 is center-registered to first spindle 42. First spindle 42 has a diameter of 17 mm, which is smaller than centering pin 14 at 22 mm. Second spindle 48 is 22 mm in diameter and is set down over first spindle 42. Second spindle 48 acts as a seal between disk-shaped replica substrate 44 and disk vacuum chuck 40 and the center-registration point for cover layer 76. While the diameters of first spindle 42 and second spindle 48 do not have to be 17 mm and 22 mm, respectively, second spindle 48 should be the same diameter as centering pin 14. Cover layer 76 contacts final curable material 74 when placed on second spindle 78. Cover layer 74 may be 120 mm in outer diameter with a hole in the center with a diameter of 22 mm. The size of cover layer 74 may be different in some embodiments, as long as the cover layer completely covers the readable surface patterns of disk-shaped replica substrate 44.

Final curable material 74 is used to attach cover layer 76 to thin films 73 with a consistent thickness. Final curable material 74 may comprise any material, such as a resin, that can be moldable in one stage to form to adhere to the adjacent substrates and can be cured afterwards to hold the readable substrates together. Final curable material 74 has a viscosity that allows the final curable material to flow over the surface of thin films 73 and cover layer 76 when forced towards the outer edge of moldable disk 44. In this embodiment, final curable material 74 has a lower viscosity than second curable material 50 from FIG. 3. However, the viscosity of final curable material 74 may be different in other embodiments.

Vacuum chuck 40 spins at a high angular speed to force final curable material 74 away from second spindle 48. Angular speeds may be between 4000 and 8000 revolutions per minute (rpm), and more ideally at approximately 6000 rpm. As final curable material 74 flows outward, thin films 73 of disk-shaped replica substrate 44 adhere to the outwardly flowing final curable material. Spinning may be performed until final curable material 74 is of desired thickness. In this embodiment, final curable material 74 is spun until it is approximately 7 μm thick. In other embodiments, the thickness of final curable material 74 may be more or less than this thickness. While second curable material 50 thickness may slightly vary radially with respect to disk-shaped replica substrate 44, thickness may be consistent in the circumferential direction. For example, the circumferential thickness variation in one rotation may be less than 2 μm. Circumferential uniformity may allow the laser drive head to accurately follow the surface pattern without refracting different degrees as the blue disk is read. This process creates a thin adhesion layer between thin films 73 and cover layer 76.

Final curable material 74 is also curable to secure cover layer 76 to thin films 73. Curing may be done by numerous methods, but this embodiment describes the use of UV light to cure final curable material 74 into a hard material. A UV light source directs UV light through cover layer 76 to harden and cure final curable material 74. Once final curable material 74 has cured, the blue disk is complete and can be removed from first spindle 42.

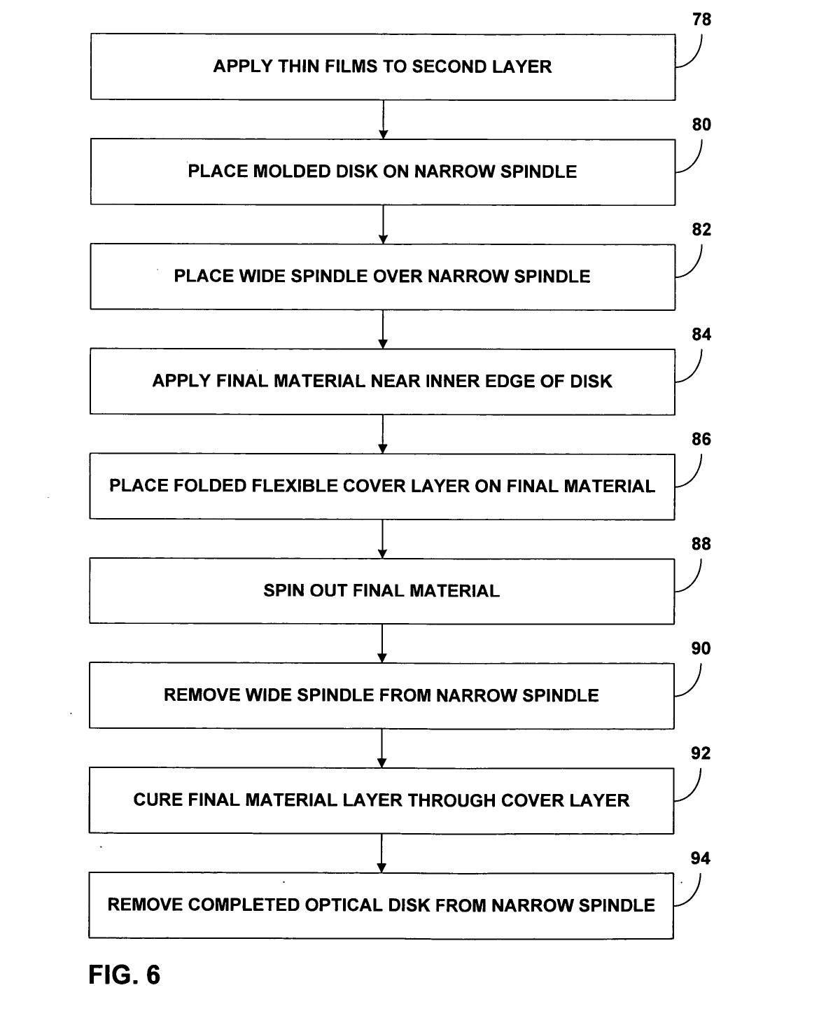

FIG. 6 is a flow diagram illustrating an exemplary method to apply a protective cover layer to a featured layer on a disk-shaped replica substrate. Disk-shaped replica substrate 44, with two data layers already formed, is treated before being placed on first spindle 42. Thin films 73 are applied to readable surface pattern 72 to provide optical refraction and a smooth surface finish to the second data layer (78). Disk-shaped replica substrate 44 is then slid down first spindle 42 until it contacts vacuum chuck 40 (80). First spindle 42 is located at the center of disk-shaped replica substrate 44 and readable surface patterns 46 and 72 are oriented opposite disk vacuum chuck 40. Next, second spindle 48 is placed over first spindle 42 (82). Second spindle 48 serves to seal disk-shaped replica substrate 44 from disk vacuum chuck 40.

Final curable material 74 is applied to thin films 73 of disk-shaped replica substrate 44 in a ring near second spindle 48 at the inner edge of disk-shaped replica substrate 44 (84). In some embodiments, multiple concentric rings or a covering layer of final curable material 74 may be applied to thin films 73. Cover layer 76 is carefully placed over second spindle 48 to contact final curable material 74 (86). In some embodiments, slight bending of cover layer 76 may be performed to help contact final curable material 74 without trapping bubbles of air between cover layer 76 and final curable material 74. At this point, cover layer 76 may only be contacting final curable material 74 near second spindle 48. Next, disk vacuum chuck 40 spins at 6000 rpm to spread final curable material 74 radially outward to fill in the space between thin films 73 and cover layer 76 (88). Once final curable material 74 is reduced to a thickness of approximately 7 μm, spinning stops. In other embodiments, the thickness of final curable material 74 may greater or less than 7 μm. Notably, the thickness of final curable material 74 may be somewhat uneven to compensate for irregularities in cover layer 76, e.g., to allow for lower cost, lower quality cover layers 76 to be used. In this case, final curable material 74 may form part of the cover structure, for purposes of compliance to a blue disk standard, such as blu-ray.

Second spindle 48 is removed from disk assembly 41 after spinning stops (90). Final curable material 74 must be cured before the blue disk is completed. A UV lamp directs UV light through cover layer 76 to cure final curable material 74 (92). In other embodiments, a different type of electromagnetic energy may be used to cure final curable material 74. Also, heat may be used instead of a UV lamp. Once final curable material 74 has cured, the completed dual layer blue disk may be removed from the first spindle (94). The blue disk includes two center-registered and concentric data layers and a protective cover layer.

In some embodiments, a cover layer may not be added to the data layers of disk-shaped replica substrate 44. Alternatively, the data layers may include optical characteristics similar to the cover layer for similar near-field optical function. For example, thin films 73 may create the expected light refraction of the cover layer. In this case, the cover layer may be eliminated from the disk construction. Further, thin films 73 may be cured to sufficiently protect the underlying readable surface pattern. Also, cover layer functionality may be included in read-out optics, to allow for near-field media construction while still complying with a blue disk standard.

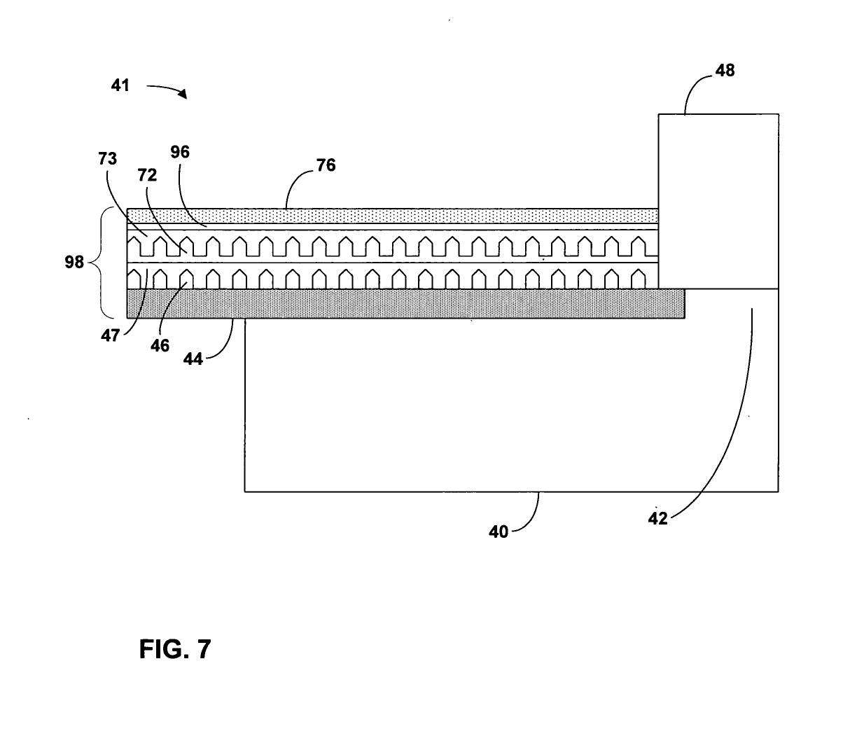

FIG. 7 is a side view of an exemplary completed dual-layer optical disk on an assembly. Blue disk 98 is completed, but not yet removed from disk assembly 41. Blue disk 98 includes disk-shaped replica substrate 44, the first data layer (readable surface pattern 46 and thin films 47), the second data layer (readable surface pattern 72 and thin films 73), final curable material 96 and cover layer 76.

The readable surface pattern for each data layer is identical and oriented in the same direction. In other words, neither pattern is the inverse of the other pattern. Once bonded together, blue disk 98 is only slightly flexible but can hold many gigabytes of data. Once second spindle 48 is removed and blue disk 98 is taken from disk vacuum chuck 40, blue disk 98 may be read by a blue-laser drive head. The laser may detect the difference in depths of each readable surface pattern and use the data to perform any number of computational functions.

First, second and final curable materials used herein may be formed from more than one component. Generally, each curable material may be created with a resin component, a photoinitiator component and a reactive dilutent component. More specifically, the makeup of each component may vary between each material. Moreover, the percentage of each component may vary between each of the first, second and final curable material. The resin component may make up the majority of the material and comprise an acrylate resin, for example. The reactive dilutent component may also be an acrylate, but the viscosity may be lower than the resin component to promote spreadability of the material. The photoinitiator component is a component that, when exposed to UV radiation, promotes cross-linking between the resin component and the reactive dilutent component. This cross-linking results in the curing of the material or the final material hardness.

In some embodiments, thin films 47 and 73 may not be added to the construction of blue disk 98. In these cases, the adjoining layers may fill in and cover the readable surface patterns. In other cases, one thin film may cover each readable surface pattern. In any case, films may be applied by spray, rolling bead, or any other method of applying a liquid without damaging the contact area.

Various embodiments of the invention have been described. For example, a stamper center-registered to a master was replicated by spinning a material radially outward. The stamper was also used with a previously formed layer of a blue disk to add a center-registered second layer of the blue disk.

Nevertheless, various modifications can be made to the techniques described herein without departing from the spirit and scope of the invention. For example, although the thickness of a readable surface pattern was described to be approximately 25 μm, other blue disks or optical disks of other formats may require different thicknesses. Also, the same techniques described herein for creating a replica disk, using a stamper, may be used to create a later generation stamper from an earlier generation stamper. These and other embodiments are within the scope of the following claims.

1. A method comprising:
centering a master on a centering pin, the master including mastered surface features;
applying a first curable material to the master near the centering pin;
placing a disk-shaped stamper substrate on the centering pin to contact the first curable material, wherein the centering pin registers the disk-shaped stamper substrate to the master;
coating the disk-shaped stamper substrate with the first curable material by spinning the master and the disk-shaped stamper substrate, wherein the first curable material coated on the disk-shaped stamper substrate forms an inverse of the mastered surface features on the master; and
curing the first curable material to the disk-shaped stamper substrate by directing light through the disk-shaped stamper substrate to form a stamper, wherein the stamper comprises the first curable material cured to the disk-shaped stamper substrate.

2. The method of claim 1, further comprising creating another stamper by repeating the steps of:
applying a first curable material to the master near the centering pin;
placing a disk-shaped stamper substrate on the centering pin to contact the first curable material, wherein the centering pin registers the disk-shaped stamper substrate to the master;
coating the disk-shaped stamper substrate with the first curable material by spinning the master and the disk-shaped stamper substrate, wherein the first curable material coated on the disk-shaped stamper substrate forms an inverse of the mastered surface features on the master; and
curing the first curable material to the disk-shaped stamper substrate by directing light through the disk-shaped stamper substrate to form another stamper.

3. The method of claim 1, further comprising creating a featured layer of an optical disk with the stamper, wherein the featured layer includes a readable surface pattern.

4. The method of claim 3, further comprising:
centering a disk-shaped replica substrate on a first spindle, wherein the first spindle has a diameter less than a second spindle;
applying a second curable material to the disk-shaped replica substrate near the second spindle;
centering the stamper on the second spindle to contact the second curable material, wherein the second spindle registers the stamper to the disk-shaped replica substrate;
coating the disk-shaped replica substrate with the second curable material by spinning the disk-shaped replica substrate, wherein the second curable material coated on the disk-shaped replica substrate creates a readable surface pattern opposite the stamper;
curing the second curable material by directing light through the stamper; and
applying one or more films to the readable surface pattern to create the featured layer.

5. The method of claim 4, further comprising:
centering the disk-shaped replica substrate on the first spindle, wherein the disk-shaped replica substrate contains the featured layer;
applying a final curable material to the disk-shaped replica substrate near the second spindle;
centering a cover layer on the second spindle to contact the final curable material;
coating the disk-shaped replica substrate with the final curable material by spinning the disk-shaped replica substrate; and
curing the final curable material by directing light through the cover layer, wherein the optical disk comprises the disk-shaped replica substrate coupled to the cover layer.

6. The method of claim 4, wherein the one or more films have an index of refraction different from the first and second curable material.

7. The method of claim 5, wherein the disks, with their respective first, second or final curable materials between them, are spun between 4000 to 8000 revolutions per minute to force the material out from the center of the disks.

8. The method of claim 5, wherein viscosities of the first curable material and the final curable material are less than a viscosity of the second curable material.

9. The method of claim 1, wherein the light comprises ultraviolet light and wherein the disk-shaped stamper substrate comprises a polymer that is transparent to ultraviolet light.

10. The method of claim 5, wherein the first, second, and final curable materials include a resin component, a photoinitiator component, and a reactive dilutent.

11. The method of claim 1, further comprising coating the stamper with a layer of nickel.

12. A method comprising:
centering a disk-shaped replica substrate on a first spindle, wherein the first spindle has a diameter less than a second spindle;
applying a curable material to the disk-shaped replica substrate near the second spindle;
centering a center-registered stamper on the second spindle to contact the curable material, wherein the second spindle registers the center-registered stamper to the disk-shaped replica substrate;
coating the disk-shaped replica substrate with the curable material by spinning the disk-shaped replica substrate, wherein the curable material coated on the disk-shaped replica substrate creates a readable surface pattern opposite an inverse surface pattern on the center-registered stamper;
curing the curable material; and
applying one or more films to the readable surface pattern to create the featured layer.

13. The method of claim 12, wherein curing the curable material comprises directing light through the center-registered stamper.

14. The method of claim 12, further comprising creating a featured layer of an optical disk with the center-registered stamper.

15. The method of claim 12, wherein the featured layer is approximately 25 microns thick.

16. The method of claim 14, further comprising:
centering the disk-shaped replica substrate on the first spindle, wherein the disk-shaped replica substrate contains the featured layer;
applying a final curable material to the disk-shaped replica substrate near the second spindle;
centering a cover layer on the second spindle to contact the final curable material;
coating the disk-shaped replica substrate with the final curable material by spinning the disk-shaped replica substrate; and
curing the final curable material by directing light through the cover layer, wherein the optical disk comprises the disk-shaped replica substrate coupled to the cover layer.

17. The method of claim 12, wherein the curable material comprises a second curable material, the method further comprising creating the center-registered stamper, wherein creating the center-registered stamper comprises:
centering a master on a centering pin, the master including mastered surface features;
applying a first curable material to the master near the centering pin;
placing a disk-shaped stamper substrate on the centering pin to contact the first curable material, wherein the centering pin registers the disk-shaped stamper substrate to the master;
coating the disk-shaped stamper substrate with the first curable material by spinning the master and the disk-shaped stamper substrate, wherein the first curable material coated on the disk-shaped stamper substrate creates an inverse surface pattern opposite the master; and
curing the first curable material by directing light through the disk-shaped stamper substrate, wherein the center-registered stamper comprises the disk-shaped stamper substrate coupled to cured first curable material.

18. A method comprising:
centering a first stamper on a centering pin, wherein the first stamper includes a surface pattern;
applying a first curable material to the first stamper near the centering pin;
placing a disk-shaped stamper substrate on the centering pin to contact the first curable material, wherein the centering pin registers the disk-shaped stamper substrate to the first stamper;
coating the disk-shaped stamper substrate with the first curable material by spinning the first stamper and the disk-shaped stamper substrate, wherein the first curable material coating the disk-shaped stamper substrate creates a surface pattern opposite the first stamper; and
curing the first curable material by directing light through the disk-shaped stamper substrate to create a next-generation stamper, wherein the next-generation stamper comprises the first curable material cured to the disk-shaped stamper substrate.

19. The method of claim 18, wherein the first stamper is created from a master that includes mastered surface features inverse of the surface pattern on the first stamper.

20. The method of claim 18, wherein the first stamper is created from a previous-generation stamper that includes a surface pattern inverse of the surface pattern on the first stamper.
